(19) United States
(12) Patent Application Publication
(10) Pub. No.: US 2006/0222850 A1
(43) Pub. Date: Oct. 5, 2006

(54) Synthesis of a self assembled hybrid of ultrananocrystalline diamond and carbon nanotubes

(75) Inventors: Xingcheng Xiao, Darien, IL (US); John A. Carlisle, Plainfield, IL (US); Orlando Auciello, Bolingbrook, IL (US); Jeffrey W. Elam, Elmhurst, IL (US); Dieter M. Gruen, Downers Grove, IL (US)

Correspondence Address: HARRY M. LEVY;EMRICH & DITHMAR, LLC, 125 SOUTH WACKER DRIVE, SUITE 2080, CHICAGO, IL, 60606-4401, US

(73) Assignee: The University of Chicago, Chicago, IL (US)

(21) Appl. No.: 11/097,603

(22) Filed: Apr. 1, 2005

(51) Int. Cl. B32B 9/00; H05H 1/24

(52) U.S. Cl. 428/408; 427/569

(57) ABSTRACT

A material of carbon nanotubes and diamond bonded together. A method of producing carbon nanotubes and diamond covalently bonded together is disclosed with a substrate on which is deposited nanoparticles of a suitable catalyst on a surface of the substrate. A diamond seeding material is deposited on the surface of the substrate, and then the substrate is exposed to a hydrogen poor plasma for a time sufficient to grow carbon nanotubes and diamond covalently bonded together.

### CONTRACTUAL ORIGIN OF THE INVENTION

The United States Government has rights in this invention pursuant to Contract No. W-31-109-ENG-38 between the U.S. Department of Energy (DOE) and The University of Chicago representing Argonne National Laboratory.

### FIELD OF THE INVENTION

The present invention relates to various combinations of carbonaceous materials, particularly those with interesting electrical and hardness properties.

### BACKGROUND OF THE INVENTION

Recent strong scientific and technological interest in nanostructured carbon materials (nanocarbons) has been motivated by the diverse range of physical properties these systems exhibit. These properties arise from the many different local bonding structures of carbon, as well as the long range order of the bonding structure. For example, carbon nanotubes (CNTs) are distinct from graphite although both consist essentially of sp²-bonded carbon. CNT's are the strongest known material and also exhibit unique electronic transport properties, making them candidates for a wide range of applications.

Similarly, nanocrystalline diamond films are distinct from single crystal diamond although both are mostly sp³-bonded carbon, and exhibit high hardness, exceptional chemical inertness, biocompatibility and negative electron affinity with properly treatment. The unique mechanical and electrochemical properties of nanocrystalline diamond make it a promising candidate as the protective coating for machining tools, hermetic corrosion resistant coating for biodevices, cold cathode electron source, and the structural material for micro- and nano-electromechanical systems (MEMS/NEMS).

It is believed that a combination of carbon nanotubes and nanocrystalline diamond provides materials with novel properties that are advantageously used in applications such as electronic devices or MEMS/NEMS. However, until now no method of providing the concurrent growth of different allotropes of carbon that are covalently bonded and organized at the nanoscale has been available.

### SUMMARY OF THE INVENTION

Accordingly, an object of the invention is to provide a synthesis of nanocrystalline diamond and carbon nanotubes to form a covalently bonded hybrid material: a nanocomposite of diamond and CNTs

Another object of the invention is to provide a material comprising carbon nanotubes and diamond covalently bonded together.

Another object of the invention is to provide a method of producing carbon nanotubes and diamond covalently bonded together, comprising providing a substrate, depositing nanoparticles of a suitable catalyst on a surface of the substrate, depositing diamond seeding material on the surface of the substrate, and exposing the substrate to a hydrogen poor plasma for a time sufficient to grow carbon nanotubes and diamond covalently bonded together.

Another object of the invention is to provide a hybrid of carbon nanotubes and diamond made by the method of providing a substrate, depositing nanoparticles of a suitable catalyst on a surface of the substrate, depositing diamond seeding material on the surface of the substrate, and exposing the substrate to a hydrogen poor plasma for a time sufficient to grow a hybrid of carbon nanotubes and diamond.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1a is a SEM showing the evolution of the hybrid UNCD/CNTs structures via adjustment of the relative fraction of catalyst and nanodiamond seeds;

FIG. 1b is a SEM showing the hybrid structures of UNCD and CNTs with a low fraction of CNTs and UNCD;

FIG. 1c is a SEM having a fully dense hybrid structure of UNCD and CNTs with a high fraction of UNCD;

FIG. 1d is a SEM showing pure UNCD;

FIG. 2a is a TEM image of CNTs prepared using PECVD with Ar/CH₄ as precursor with different diameters of CNTs ranging from 2 to 10 nm;

FIG. 2b is a HRTEM image of CNTs multiwalled with well-ordered graphene sheets and typical defect densities;

FIG. 3 is a graphical representation of a Raman spectra of CNTs, UNCD and UNCD/CNTs hybrid structures corresponding to the samples shown in FIGS. 1a, b-d, respectively;

FIG. 4 is a graph of C 1s NEXAFS of CNTs, UNCD and UNCD/CNTs hybrid structures, corresponding to the samples shown in FIGS. 1a-d, respectively. nanodiamond seeds; and

FIGS. 5-15 are SEM images of covalently bonded diamond and CNTs of the hybrid materials.

### DETAILED DESCRIPTION OF THE INVENTION

One of the most commonly used processes for preparing nanostructured carbon materials is plasma enhanced chemical vapor deposition (PECVD), in which chemically activated carbon-based molecules are produced; however, this invention includes any known method of depositing nanostructural carbon materials. For instance, different carbon-rich combinations of C₂H₂/H₂, C₂H₂/NH₃, and CH₄/Ar have been employed for growing CNTs. In contrast, hydrogen-rich (˜99% H₂) CH₄/H₂ plasmas are the most common mixtures used for growing microcrystalline diamond films, wherein large amounts of atomic hydrogen play a critical role in both the gas-phase and surface growth chemistries. Importantly, atomic hydrogen is also needed to selectively etch the non-diamond carbon during growth. Over the past several years Argonne National Laboratory (ANL) has developed hydrogen-poor Ar/CH₄ (99% Ar, 1% CH₄) chemistries to grow ultrananocrystalline diamond (UNCD) films, which consist of diamond grains 3-5 nm in size and atomically abrupt high energy grain boundaries, as described by A. Krauss, O. Auciello, D. Gruen, A. Jayatissa, A. Sumant, J. Tucek, D. Mancini, N. Moldovan, A. Erdemir, D. Ersoy, M. Gardos, H. Busmann, E. Meyer, M. Ding, Diamond Relat. Mater. 2001, 10, 1952, incorporated herein by reference.

The special nanostructure of UNCD yields a unique combination of properties, such as low deposition temperatures, described by X. Xiao, J. Birrell, J. E. Gerbi, O. Auciello, J. A. Carlisle, J. Appl. Phys. 2004, 96, 2232, incorporated herein by reference, excellent conformal growth on high-aspect ratio features, described by A. Krauss, O. Auciello, D. Gruen, A. Jayatissa, A. Sumant, J. Tucek, D. Mancini, N. Moldovan, A. Erdemir, D. Ersoy, M. Gardos, H. Busmann, E. Meyer, M. Ding, Diamond Relat. Mater. 2001, 10, 1952, incorporated herein by reference and the highest room-temperature n-type electronic conductivity demonstrated for phase-pure diamond films via nitrogen doping at the grain boundaries, as described by S. Battacharyya, O. Auciello, J. Birrell, J. A. Carlisle, L. A. Curtiss, A. N. Goyete, D. M. Gruen, A. R. Krauss, J. Schlueter, A. Sumant, P. Zapol, Appl. Phys. Lett. 2001, 79,1441. incorporated herein by reference.

It is important to recognize that the composition and morphology of the material grown is not simply a function of the gas mixture and plasma conditions, but also depends sensitively on the pretreatment of the substrate prior to growth as well as the substrate temperature. It is widely known that there is a high nucleation barrier for growing carbon based materials and that certain pre-treatments are necessary to provide the initial nucleation sites. For example, nanoparticles of transition metals, such as Ni, Fe and Co are used as catalysts for growing CNTs, whereas micro or nano-diamond UNCD powders are typically needed to be present on the substrate surface prior to the diamond growth. In addition, the temperature window for PECVD growth of CNTs ranges from 150° C. while UNCD films can be prepared at temperature ranged from 400° C. to 800° C.

Experimental

Iron films with different thickness (˜5˜40 nm) were deposited on silicon substrates using an ion beam sputtering deposition system with a Kr ion gun. The coated samples were then immersed into a suspension of ˜5 nm diamond particles in methanol and ultrasonically vibrated for different periods of time in order to control the nucleation density for the growth of UNCD. Next, the seeded films were inserted into a microwave plasma deposition system (IPLAS) and heated at 800° C. in flowing hydrogen (90 sccm, 20 mbar) for 30 minutes to coalesce the iron films into nano-sized iron particles to catalyze CNTs formation. The iron film thickness determines the size of the catalyst particles, which subsequently determines the diameter of CNTs. Following the pretreatment described above, the substrate was cooled down to 700° C. and a plasma consisting of 99% Ar with 1% CH₄ was initiated to grow the carbon nanocomposite.

A number of specific experiments used the following protocol:

Experimental Details:

1. Clean the substrate (Silicon, Silcion oxide, W and other carbide formed metal) using acetone and methanol for 5 minutes separately.

2. Sputter the transition metals (Fe, Ni, Co) to the cleaned substrate with different thickness (0, 5, 10, 20 and 40 nm).

3. Ultrasonically seed the substrate in nanodiamond suspension (3 mg nano diamond powder in 100 ml methanol) with different time (0, 5, 15, 30 minutes), then rinse with methanol.

4. Heat the sample up to 800° C. and input H₂ flow (90 sccm, 20 mbar) for 20 minutes to reduce the possibly oxidized metal and break the continuous film into nano particles. The size and density of nano particles are dependent of thickness of metal films and in turn influence the diameters and density of carbon nanotubes accordingly.

5. Decrease the substrate temperature down to 600˜700° C. and switch off the hydrogen flow, wait for 5 minute pumping down.

6. Expose the treated substrate to hydrogen poor Ar/CH₄ plasma (49 sccm Ar and 1 sccm CH₄, the typical flow rate for growing ultrananocrystalline diamond) for different time (10, 20, 30 minutes).

We determined the following from the experimental data:

1. The relative fraction of ultrananocrystalline diamond and carbon nanotubes is controlled by the combination of seeding time, thickness of catalyst thin films and growth time.

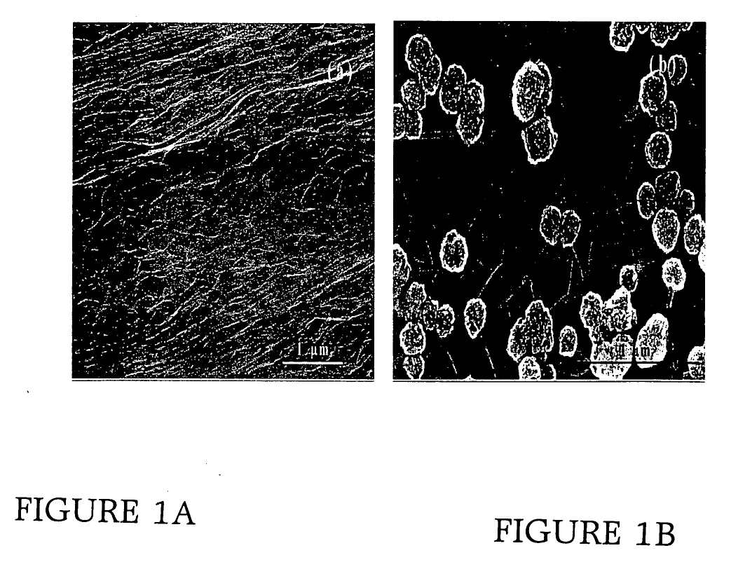

2. Thickness of the catalyst thin films not only control the catalyst particle size but also control the catalyst density, which in turn control the diameter and density of catalyst.
Pure ultrananocrystalline diamond is obtained without catalyst deposition on substrate, as shown in FIG. 1a;
Nerve structures are obtained with process of 5 minute seeding, 10 nm catalyst and 10 minute growth; as shown in FIG. 1b;
Structure with the protrusion of carbon nanotubes through supergrain boundaries are obtained with the process parameters of 30 minute seeding, 10 nm catalyst, 30 minute growth, as shown in FIG. 1c;
Pure UNCD are obtained without transition metal sputtering as shown in FIG. 1d;

3. Setting the process parameters in the overlapped process windows resulted in carbon nanotubes and ultrananocrystalline diamond.

4. Patterned templates for seeds and catalyst were utilized to simultaneously and selectively grow carbon nanotubes and ultrananocrystalline diamond to fabricate the prototype of electronic devices.

5. Uniform distribution of carbon nanotubes in diamond matrix enhances the fracture roughness of diamond thin films and overcomes the shortcomings of brittleness.

The hybrid nanostructures were studied using a Hitachi S-4700 field emission Scanning Electron Microscope (SEM) at 10 kV accelerating voltage and a TECNAI 20 Transmission Electron Microscope (TEM) with Electron Energy Loss Spectroscopy (EELS) at 100 kV accelerating voltage. The hybrid films were also analyzed with visible Raman spectroscopy using a Renishaw Raman microscope in the backscattering geometry with a HeNe laser at 633 nm and an output power of 25 mW focused to a spot size of ˜2 μm. Near Edge X-ray Absorption Fine Structure (NEXAFS) analysis was performed at the Advanced Light Source of Lawrence Berkeley National Laboratory. The diamond reference sample was a standard Type IIa diamond. The graphite reference sample was a highly oriented pyrolitic graphite (HOPG).

By selectively placing the catalyst and nanodiamond powders on the same substrate, carbon nanotubes and UNCD can be grown. The relative fraction of UNCD and CNTs can be varied by controlling the relative amounts of transitional metal catalysts and nanodiamond seeds. The first successful preparation of the hybrid CNT/UNCD nanostructures using this approach is set forth hereafter.

FIG. 1 shows SEM images revealing the structural evolution from pure CNTs to pure UNCD films as the relative fraction of Fe and diamond nanoparticles was varied. Pure CNTs (FIG. 1a) were observed when only Fe catalyst particles were present on the substrate, whereas “normal” UNCD resulted when only nanodiamond particles were present (FIG. 1d). Seeding with both types of catalyst particles leads to the simultaneous growth of both UNCD and CNT in all cases, but controlling the relative amounts of these two allotropes further requires careful control of temperature and deposition time, since CNTs normally grow much faster than UNCD. This is shown in the SEM data presented in FIGS. 1b and 1c. For sufficiently short deposition times (˜30 min.), the formation of isolated “supergrains” consisting of many nanosized crystalline diamond grains on the substrate is observed. Since the catalyst and nanodiamond powder were present at the same time in the plasma, UNCD and CNTs were simultaneously grown on those seeds and catalyst. The supergrains shown in FIG. 1b appear, in fact to be interconnected by CNTs, with both ends of some individual nanotubes terminating on different supergrains. It is possible that the plasma environment causes local charging effects that lead to attractive forces to arise between the UNCD supergrains and CNTs, but it is also possible that UNCD and CNT can grow into each other.

It may be that the CNTs and UNCD are covalently bonded together or it may be that the combination is a hybrid, but whichever form it may be, the composition is new. To realize useful materials such as for MEMS and wear-resistant coatings, it will be necessary to produce fully-dense that is substantially free of voids, covalently-bonded (or hybrid) structures. FIG. 1c shows a SEM image of a material that very nearly realizes this goal. Further increase of the diamond nucleation density relative to the Fe catalyst enhanced the growth of UNCD relative to CNTs, and the CNTs are clearly present at the boundaries between the supergrains (FIG. 1c). Energy-dispersive x-ray (EDX) data (not shown) revealed the presence of Fe at the tips of the structures between the supergrains.

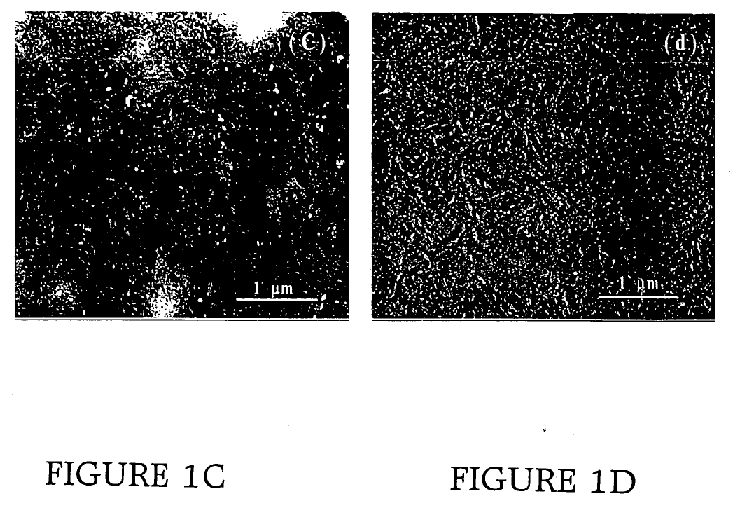

The carbon nanotubes shown in FIG. 1a were further investigated by TEM (FIG. 2), which showed a typical bundled multiwall (MWCNT) morphology. The catalytic particles were also observed, as shown in the top left area of FIG. 2a. HRTEM images revealed that the nanotubes had diameters in the range of about 2 to 10 nm and the nanotube walls were comprised of reasonably well-ordered graphene sheets. The carbon nanotubes are defective, as is typical for CNTs prepared by PECVD under these conditions. Furthermore, the HRTEM and EELS results on the sample shown in FIG. 1b confirmed the coexistence of CNTs and UNCD (not shown here).

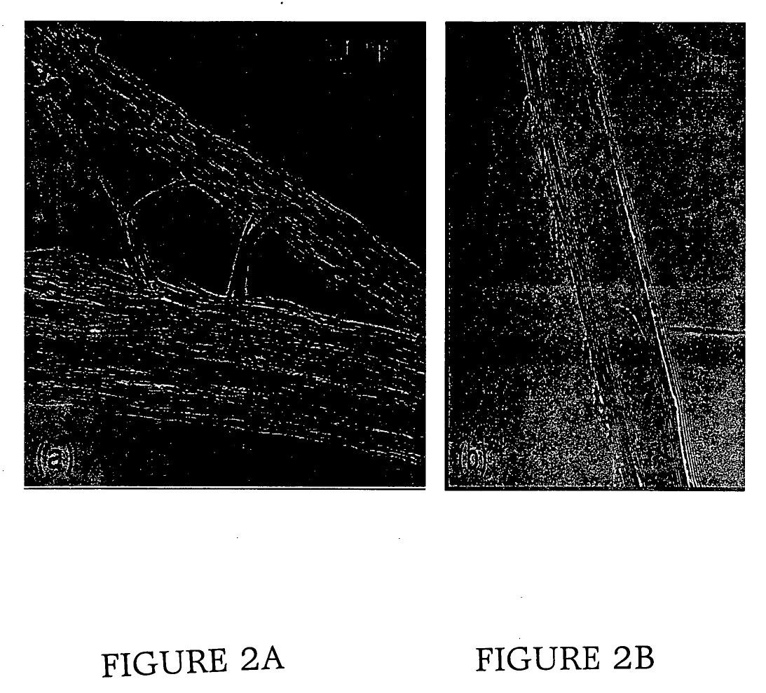

FIG. 3 compares the Raman spectra of UNCD, CNT, and the UNCD/CNT nanocomposite in the range 100˜300 cm−1. Radial breathing mode (RBM) peaks are clearly observed in the Raman spectra of CNTs and the nanocomposite, which indicates the presence of small diameter single- or double-wall CNTs, in addition to the somewhat larger diamond MWCNT that were observed via TEM. Interestingly, the peak positions in the pure CNT sample compared to the hybrid UNCD/CNTs materials are consistently different, which may be indicative of slightly different growth regimes for the two materials (e.g. the presence of only Fe particles versus Fe+ nanodiamond particles). The estimated inner-diameters are on the order of one nm, which may correspond to the some of the smaller CNTs shown in HRTEM pictures. No RBM is detected in pure UNCD, even for the graphitic phase along the grain boundaries. Further research is undergoing in our lab to explore the relationships between the RBM peaks and process parameters.

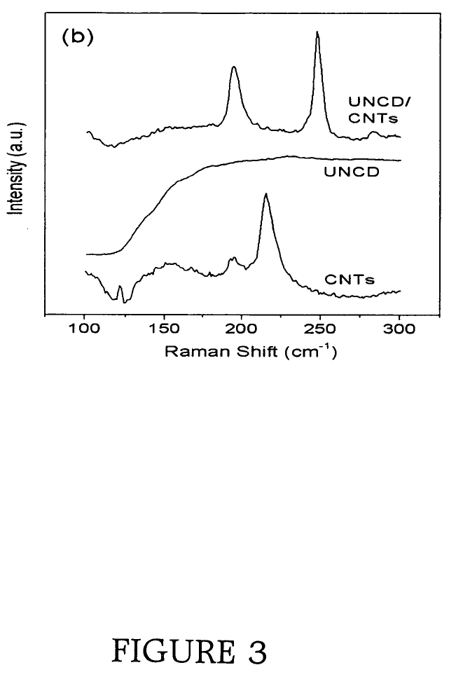

Near-edge x-ray absorption fine structure (NEXAFS) is a useful tool to unambiguously distinguish the sp² bonding and sp³ bonding in carbon materials. C (1s) NEXAFS data obtained from pure CNTs, pure UNCD, and the UNCD/CNT shown in FIG. 1c are shown in FIG. 4. UNCD films consist of about 95% sp³-bonded carbon, with 5% sp² bonded carbon within the grain boundaries which occupy 10% of the UNCD volume. Thus the C 1s NEXAFS from UNCD looks similar to data obtained from high-quality microcrystalline diamond or single crystal diamond except for the presence of an sp² π* peak at 285.5 eV. In contrast, the spectrum obtained from the pure CNTs sample looks very similar to those obtained from a typical graphite reference (highly oriented pyrolytic graphite), with both the π* at 285.5 eV and the sp² σ* core exciton at ˜291.5 eV clearly visible. This is consistent with the observation of good local order in the CNTs shown in FIG. 2.

The NEXAFS spectrum of a CNT/UNCD hybrid structure shows the combined signals from both CNTs and diamond. The peak intensity around 285 eV in the nanocomposite is higher and the dip around 302 eV is shallower than the corresponding ones in UNCD, implying a slightly higher fraction of the graphite phase resulting from CNTs and the grain boundaries of UNCD. These data provide direct evidence that the growth of UNCD (and probably CNTs) proceed independently in the hybrid as they do during the growth of the composite.

It is the overlap of the process parameters for growing UNCD and CNTs, in particular the reduced amount of atomic hydrogen, that makes it possible to simultaneously grow the UNCD/CNT hybrid. CNTs grow readily in Ar-rich Ar/CH₄ discharges due to the abundance of C₂H₂ in these plasmas via the thermal decomposition of CH₄ at 1600 K plasma temperatures. It is believed that C₂H₂ decomposed on the Fe nanoparticles, leading to the formation and diffusion of carbon atoms in the catalyst and the growth process for CNTs. However, several other carbon species have also been considered as growth species for CNTs, including CH₃ which is widely regarded as the principal growth species for most PECVD deposited diamond thin films. Our data indicate that the relative proportion of the two species is governed by kinetics and not the competing energetics of CNTs and UNCD growth. In previous work it was demonstrated that the same hydrogen-poor plasmas can still selectively etch the sidewalls of the horizontally oriented MWCNTs under an Ar-rich Ar/CH₄ discharge, leading to the growth of graphitic structures on the sidewalls, as described by S. Trasobares, C. P. Ewels J. Birrell, O. Stephen, B. Q. Wei, J. A. Carlisle, D. Miller, P. Keblinski, P. M. Ajayan, Adv. Mat. 2004, 16, 610, incorporated herein by reference.

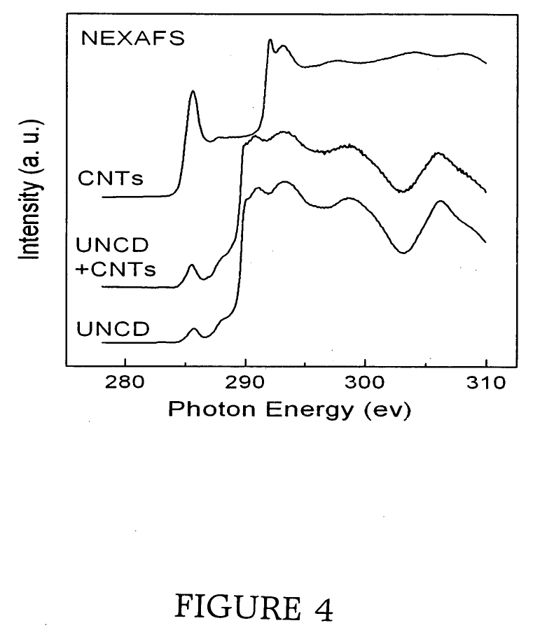

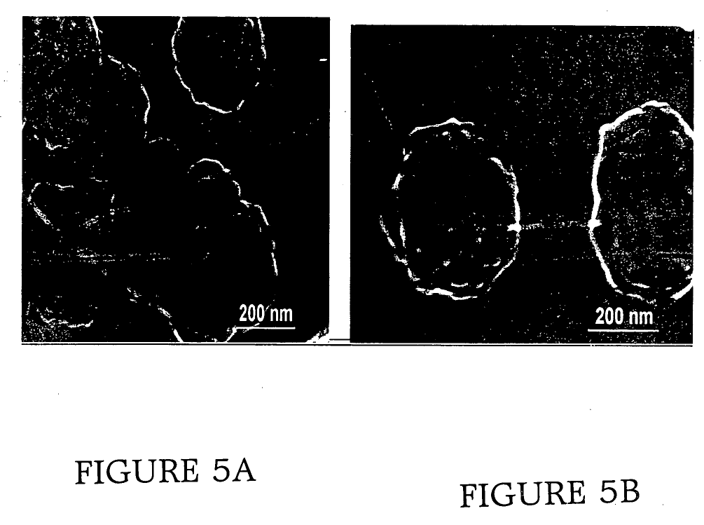

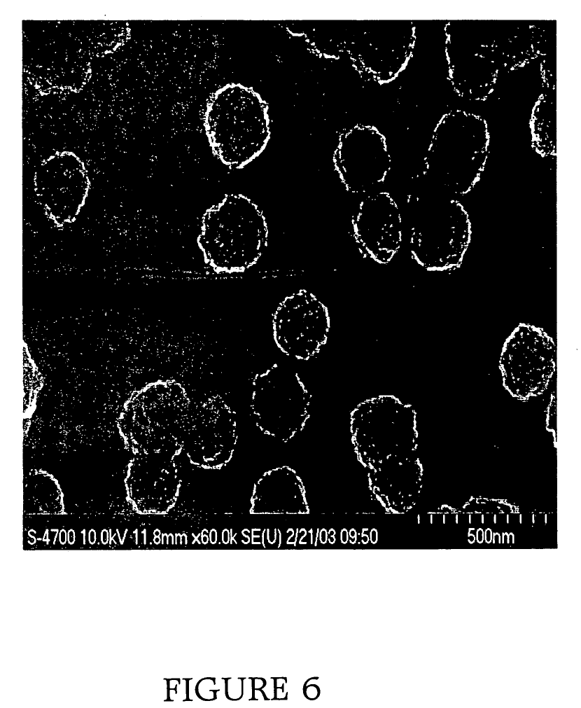

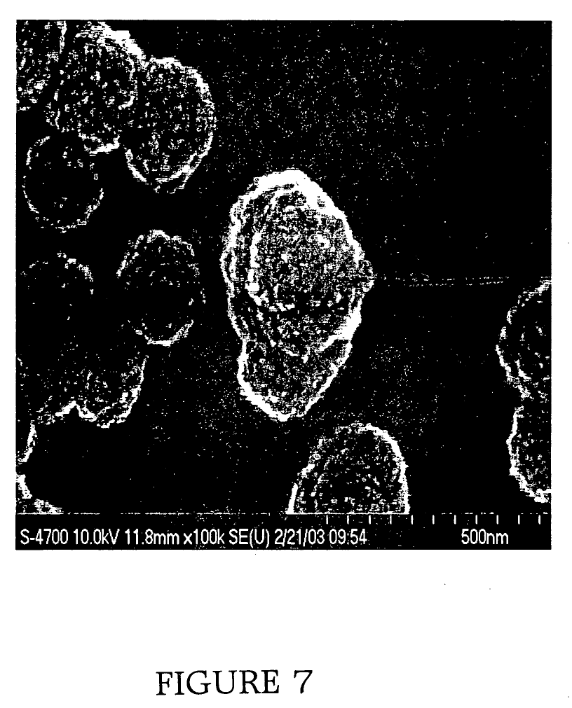

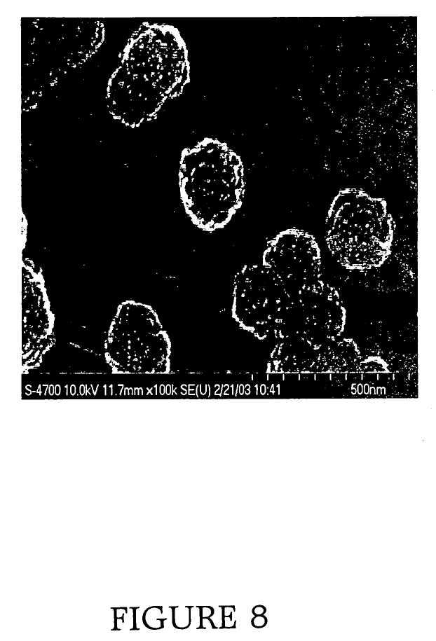

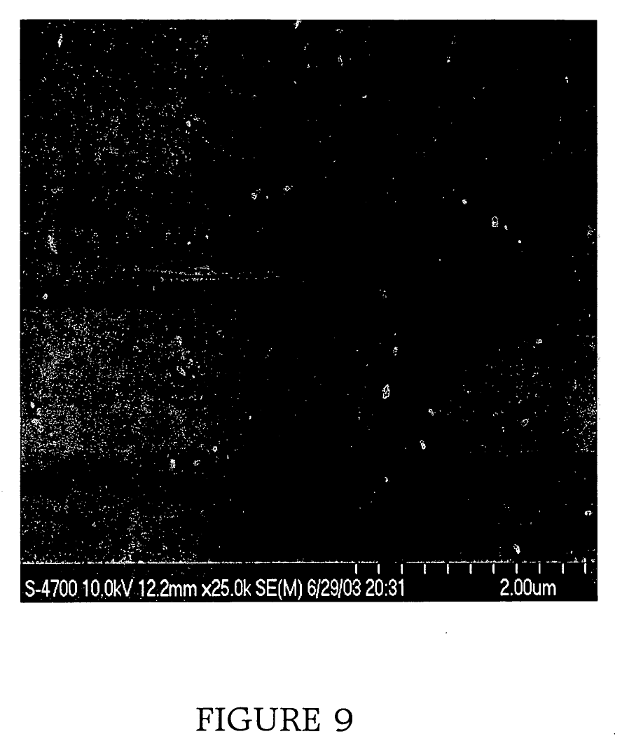

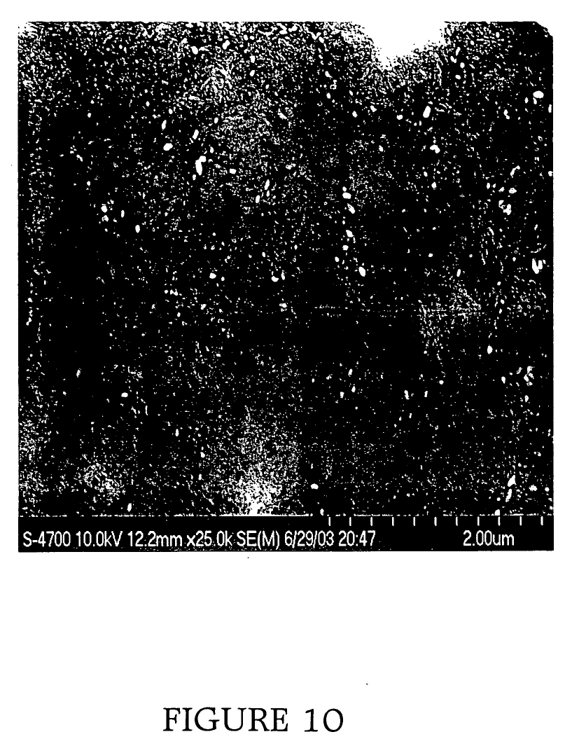

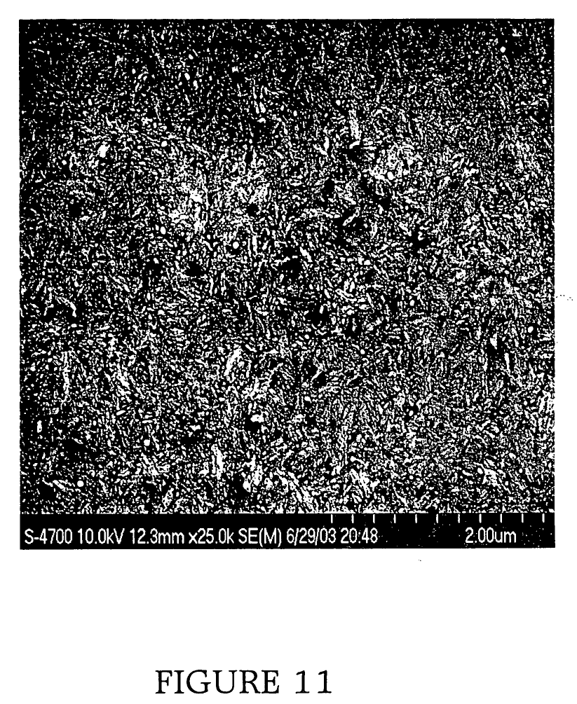

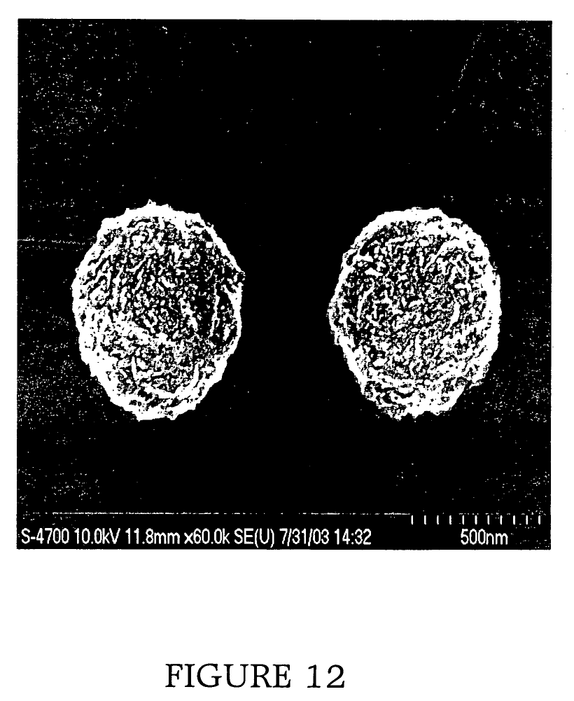

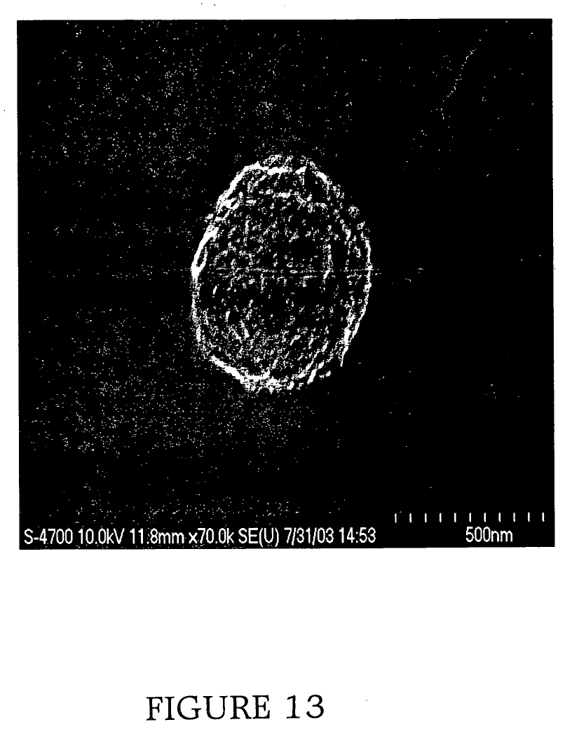

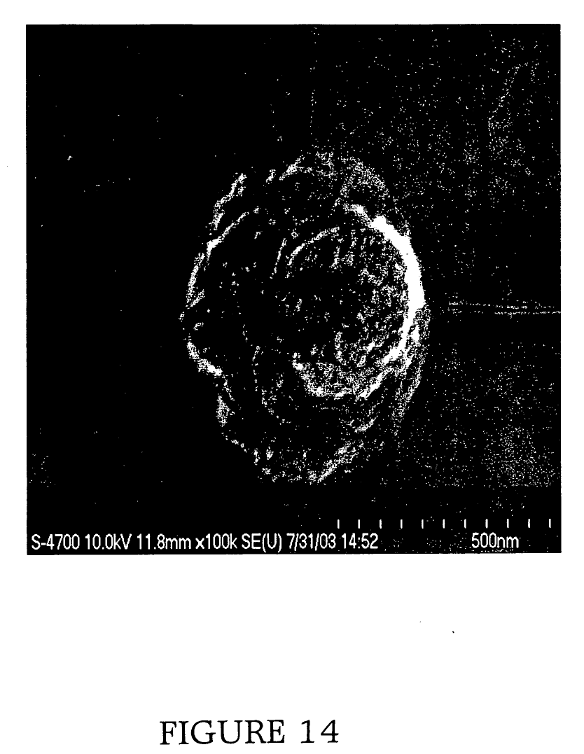

Since the process parameters for growing both nanocarbon materials are the same in Ar/CH₄ plasma, the key factor determining the subsequent nanostructural development is the initial nucleation sites. Fabricating periodic arrays of UNCD and CNTs by patterning nanodiamond and catalyst particles with the aid of lithographic techniques such as electron-beam lithography, n-type conductive various geometries such as films of heterojunctions between conductive UNCD and CNTs are capable of being produced, such as but not limited to semiconductors, MEMS devices and the like and FIGS. 5-15 are SEM images of the hybrid materials produced by the methods disclosed herein.

To summarize, a new synthesis pathway has been developed to combine different allotropes of carbon at the nanoscale in covalently bonded structures. The synthesis of a hybrid nanocarbon material consisting of ultrananocrystalline diamond and carbon nanotubes has been successfully demonstrated for the first time, via the exposure of a surface consisting of nano-sized diamond powders and iron nanoparticles to a hydrogen-poor carbon-containing plasma. This method offers a novel approach to modulate the relative ratio of sp²- and sp³-bonded carbon to form self-assembled carbon nanostructures that is amendable to modern patterning techniques to further organize these structures for useful purposes. Potential applications of these new hybrid structures ranging from nano-electronics to bio-MEMS.

In the manufacture of a variety of devices, such as semiconductors, a substrate such as but not limited to W, Ta, Ti, Mo, Cu, Si, SiO₂, mixtures and alloys thereof may be used. The diamond may be nanocrystalline or UNCD and may be electrically conducting or not. Nitrogen doping of UNCD provides an n-type electrical conductor.

While the invention has been particularly shown and described with reference to a preferred embodiment hereof, it will be understood by those skilled in the art that several changes in form and detail may be made without departing from the spirit and scope of the invention.

1. A material comprising carbon nanotubes and diamond covalently bonded together.

2. The material of claim 1, wherein said diamond is substantially all nanocrystalline diamond.

3. The material of claim 1, wherein said diamond is substantially all ultrananocrystalline diamond.

4. The material of claim 1, wherein said diamond is electrically conducting.

5. The material of claim 1, wherein said diamond is an N-type semiconductor.

6. The material of claim 1, wherein said carbon nanotubes have diameters in the range of from about 2 to about 10 nanometers.

7. The material of claim 1, wherein said carbon nanotubes include both single and multiple walled tubes.

8. The material of claim 1, in the form of a thin film having a thickness not less than about 3 nanometers (nms).

9. The material of claim 8, wherein said film is substantially free of voids.

10-20. (canceled)

21. A hybrid of carbon nanotubes and diamond made by the method, comprising providing a substrate, depositing nanoparticles of a suitable catalyst on a surface of the substrate, depositing diamond seeding material on the surface of the substrate, and exposing the substrate to a hydrogen poor plasma for a time sufficient to grow a hybrid of carbon nanotubes and diamond.

22. The hybrid of claim 26, wherein said substrate is Si and/or SiO₂, said catalyst is one or more of Fe, Ni and Co, and mixtures or alloys thereof, said diamond seeding material is nanocrystalline diamond powder, and said plasma includes at least about 99% Ar.

23. The hybrid of claim 21, in the form of a thin film having a thickness of about 3 nms to about 3 micrometers and is substantially free of voids.

24. The hybrid of claim 23, wherein said diamond is UNCD and is electrically conducting.

25. A material characterized by its SEMs substantially as shown in FIGS. 5-14.

26. The hybrid of claim 21 wherein said suitable catalyst is a transition metal or mixtures or alloys thereof.

27. A combination of intermixed CNTs and supergrains of UNCD.

28. The combination of claim 27, wherein said supergrains of UNCD contain UNCD having average diameters in the range of from about 3 to about 5 nms.

29. A film of UNCD having atomically abrupt grain boundaries and CNTs at least some of which extend through said atomically abrupt grain boundaries.

30. The film of claim 29, wherein said film has a thickness in the range of from about 3 nms to about 3 micrometers and is substantially free of voids.

31. The film of claim 30, wherein said UNCD has average diameters in the range of from about 3 to about 5 nms and at least some of said UNCD form supergrains.

32. A film of UNCD and CNTs with said CNTs randomly oriented with respect to said UNCD and distributed in a predetermined pattern.

33. A thin film formed by the simultaneous deposition of UNCD and CNTs on a substrate.
